(19) United States
(12) Patent Application Publication
(10) Pub. No.: US 2010/0138022 A1
(43) Pub. Date: Jun. 3, 2010

(54) APPARATUS FOR CONTROLLING COMPONENT OF APPLICATION AND METHOD THEREOF

(75) Inventors: Sangchul OH, Daejeon-City (KR); Namhoon Park, Daejeon-City (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-City (KR)

(21) Appl. No.: 12/629,820

(22) Filed: Dec. 2, 2009

(30) Foreign Application Priority Data
Dec. 3, 2008 (KR) 10-2008-0121644
Mar. 27, 2009 (KR) 10-2009-0026527

(51) Int. Cl. G06F 19/00

(52) U.S. Cl. 700/100

(57) ABSTRACT

An apparatus for controlling components of an application includes an assembly controller that outputs a driving control signal by using an application, at least one component, and a resource factory that controls the driving of the component based on the driving control signal output from the assembly controller, wherein the resource factory confirms the workload of a component in the corresponding resource factory and senses the congestion situation according to the workload of the component to control the number of components in the corresponding resource factory.

### RELATED APPLICATIONS

The present application claims priority to Korean Patent Application Serial Number 10-2008-0121644, filed on Dec. 3, 2008 and Korean Patent Application Serial Number 10-2009-0026527, filed on Mar. 27, 2009, the entirety of which is hereby incorporated by reference.

### BACKGROUND OF THE INVENTION

1. Field of the Invention

The present invention relates to an apparatus for controlling components of an application and a method thereof, and in particular, to an apparatus for controlling components of an application to dynamically perform a congestion control at the corresponding component level when congestion situation occurs during the operation of the application and a method thereof.

2. Description of the Related Art

A Software Communication Architecture (SCA) is a standardized communication software structure to largely improve interoperability between communication systems and to reduce development and distribution costs, which was proposed by Joint Tactical Radio System (JTRS) Joint Program Office (JPO), USA.

The SCA adopts a real time operating system (OS) and a Common Object Request Broker Architecture (CORBA), which is industry standard of a distributed object model, as middleware to provide an integrated environment of a different type of hardware and software. Herein, the SCA is an independent system design framework rather than a standard limited to a specific system.

The SCA binds several components into one package as the application that performs one waveform function and installs and arranges it in hardware and then operates it. A representative example adopting the SCA may include an SDR system. The SDR system adopts the SCA as a standard of a software framework.

The application having the SCA structure basically manages the operations of install, instantiation, start, stop, shutdown, uninstall, etc., in one application level. In this case, the application package should be fabricated using the component configuration that expects the congestion situation beforehand and prevents the expected congestion situation, in a step of fabricating the application software package. In addition, there is a method of sufficiently preparing the components or additionally fabricating components for controlling congestion against the occurrence of the congestion situation.

However, it is difficult to accurately expect when congestion would occur at the step of fabricating the application software package. There are problems in that the method of sufficiently preparing the components or additionally fabricating components for controlling congestion so as to prevent the occurrence of the congestion situation also incurs high expenses and inefficiently operates the application. A need exists for a scheme capable of stably operating the application when unexpected congestion situation occurs.

### SUMMARY OF THE INVENTION

The present invention proposes to solve the problem in the related art. It is an object of the present invention to provide an apparatus for controlling components of an application capable of stably operating application when congestion situation occurs at a component level without separately requiring an expensive component for controlling congestion or a high-performance component while maintaining the existing application structure as it is and a method thereof.

It is another object of the present invention to provide an apparatus for controlling components of an application capable of dynamically performing congestion control according to an occurrence amount of congestion situation at a component level during the operation of the application and a method thereof.

In order to achieve the above objects, there is provided an apparatus for controlling components of an application according to the present invention, including: a resource factory that controls driving of built-in component, wherein the resource factory includes a confirmation unit that confirms a workload of the built-in component and a controller that determines whether the corresponding component is congested according to the workload confirmed by the confirmation unit and controls the increase and decrease of the component by the above determination.

The controller compares the workload of the confirmed component with a registered congestion control threshold to determine whether the corresponding component is congested.

It is determined that the congestion situation occurs in the component, the controller adds one or more component.

When the congestion situation occurs in the component, the controller sequentially adds components.

When the congestion situation occurs in the component, the controller sequentially adds a plurality of components according to the congestion amount occurring in the component.

The controller divides work assigned to the component that is in the congestion situation and assigns the divided work to the added one or more component.

The controller adds components until the workload of the component that is in the congestion situation is the registered congestion control threshold or less.

The controller confirms the workload of the added component from the confirmation unit when the congestion situation occurs to remove the worked component among the added components.

The resource factory is provided in plural.

The plurality of resource factories are set connection between each resource factory.

The resource factory includes an input port receiving signals transmitted from other resource factories and an output port that transmits signals from the corresponding resource factory to other resource factories.

In order to achieve the above objects, a method for controlling components of an application according to the present invention is a method for controlling components of an application including a resource factory that controls driving of a built-in component. The method for controlling components of an application includes confirming the workload of a built-in component by the resource factory; determining whether the corresponding component is congested according to the confirmed workload in the confirmation step; and controlling the increase and decrease of the component according to the determination result.

The determining includes comparing the workload of the component built in the corresponding resource factory and a registered congestion control threshold.

When the workload of the component built in the corresponding resource factory exceeds the registered congestion control threshold according to the comparison result of the comparing step, it is determined that the congestion situation occurs.

If it is determined that the congestion situation occurs in the component, the controlling includes adding one or more component.

The adding sequentially adds components.

The adding the components adds a plurality of components according to the congestion amount occurring in the components.

The method further includes dividing work assigned to the components that are in the congestion situation and assigning the divided work to the added components

The adding is performed until the workload of the components that are in the congestion situation is the registered congestion control threshold or less.

The controlling further includes confirming the workload of the added components to remove the worked components among the added components.

With the present invention, since the congestion control of application is dynamically performed at the component level, it can stably drive and operate application by dynamically performing a balancing under the unexpected congestion situation without separately requiring an expensive component for controlling congestion or a high-performance component while maintaining the existing application structure as it is.

### BRIEF DESCRIPTION OF THE DRAWINGS

FIG. 1 is a diagram showing a SCA structure applied to the present invention;

FIG. 2 is a diagram showing a configuration of an application according to the embodiment of the present invention;

FIG. 3 is a diagram showing a configuration of a resource factory according to the embodiment of the present invention;

FIG. 4 is a diagram showing driving of an application according to an exemplary embodiment of the present invention;

FIG. 5 is a flowchart showing an operational flow of a method for driving application according to the embodiment of the present invention; and

FIG. 6 is a flowchart showing an operational flow of a method for controlling congestion according to the embodiment of the present invention.

### DETAILED DESCRIPTION OF THE PREFERRED EMBODIMENTS

Hereinafter, exemplary embodiments of the present invention will be described with reference to the accompanying drawings.

The present invention relates to an apparatus for controlling components of an application. The embodiment to be described below describes an example of controlling components of an application based on an SCA structure, but is not limited thereto.

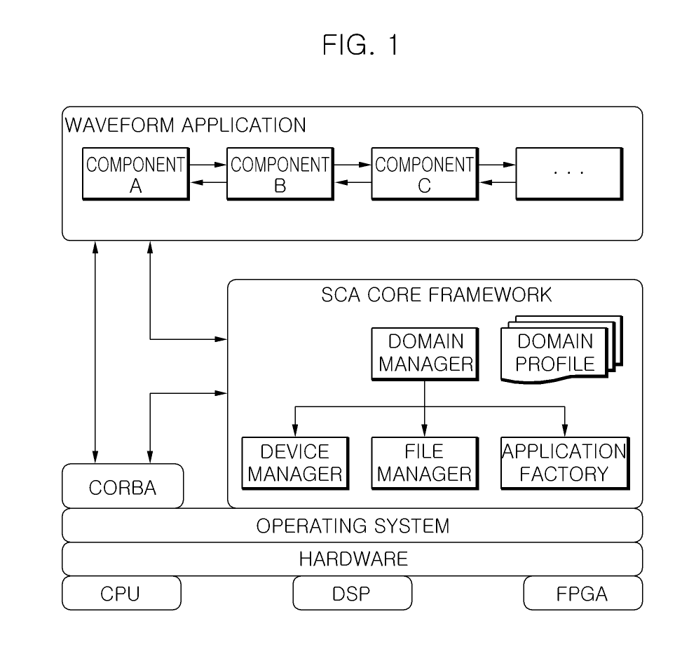

First, FIG. 1 shows a basic structure of an SCA infrastructure system.

Referring to FIG. 1, in the Software Communications Architecture (SCA) structure, an Operating System (OS), a Common Object Request Broker Architecture (CORBA), and an SCA Core Framework (CF) are disposed on an upper layer of hardware, such as a Central Processing Unit (CPU), a Digital Signal Processor (DSP), or a Field Programmable Gate Array (FPGA).

Herein, managers such as a domain manager, a device manager, a file manager, and an application factory and a domain profile in an XML file formatat exist in the SCA core framework.

Several managers of the SCA core framework arrange several components of an upper waveform application (hereinafter, referred to as ‘application’) in the corresponding hardware based on the domain profile and executes them. At this time, each component uses the corresponding ports depending on the connection setting defined in the SCA to transmit and receive information therebetween. The connection of each component is set in one way and connection setting information and port information corresponding thereto between each component are defined in the domain profile in the XML file format.

Therefore, when the component in the waveform application arranged in hardware in the SCA structure is congested, the present invention proposes the waveform application package when the congestion situation occurs.

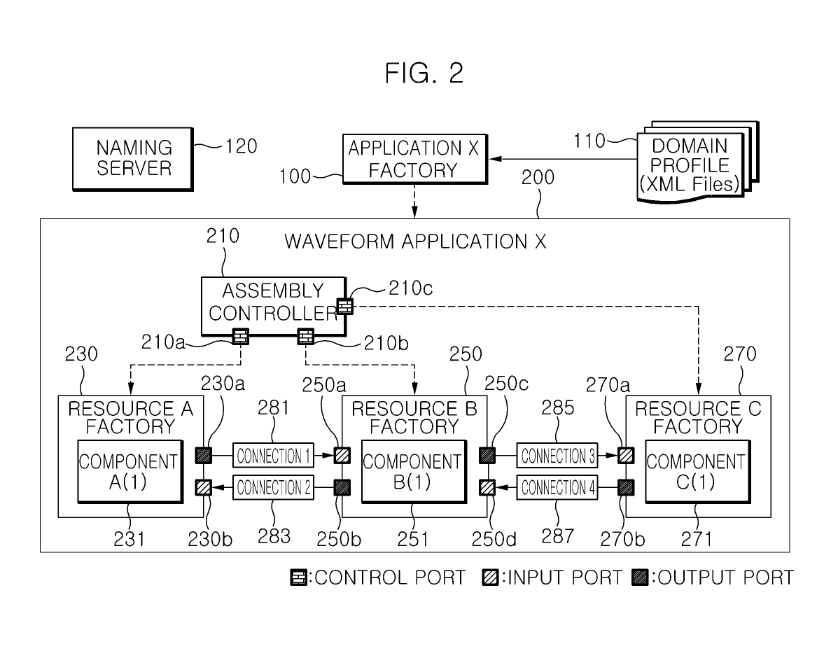

FIG. 2 shows a structure of the application according to the embodiment of the present invention and shows a structure of an SCA based application package proposed in the present invention.

Referring to FIG. 2, the application X 200 in the SCA structure is configured to include the application X factory 100 of the SCA core framework and the application X factory 100 configures and drives the application X 200 based on the profile information of the application X 200 defined in the domain profile 110.

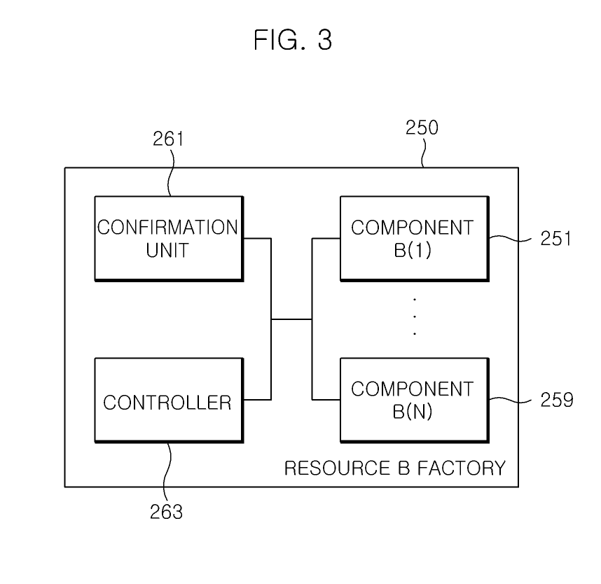

The application X 200 includes an assembly controller 210 and a plurality of resource factories. The resource factories include an input port and an output port for communicating with the component in other resource factories within the application X 200. At this time, each resource factory basically includes one component and may be dynamically formed in plural according to the congestion situation of the corresponding component. The detailed embodiment thereof will be described with reference to FIG. 3.

The embodiment of FIG. 2 explains a case where three resource factories are provided for sake of convenience, but is not limited thereto. At this time, three resource factories provided in the application X 200 is each considered to be resource A factory 230, resource B factory 250, and resource C factory 270. Further, the component included in the resource A factory 230 is assumed to be the component A(1) 231. Further, the component included in the resource B factory 250 is assumed to be the component B(1) 251. Further, the component included in the resource C factory 270 is assumed to be the component C(1) 271.

Herein, the resource A factory 230 includes an input port 230b and an output port 230a for communicating with the resource B factory 250 in the application X 200. Also, the resource B factory 250 includes an input port 250a and an output port 250b for communicating with the resource A factory 230 in the application X 200. Meanwhile, the resource B factory 250 includes an input port 250d and an output port 250a for communicating with the resource C factory 270 in the application X 200. Further, the resource C factory 270 includes an input port 270a and an output port 270b for communicating with the resource B factory 250 in the application X 200.

The assembly controller 210 sets the connection of each resource factory 230, 250, and 270 in the application

X 200 and outputs signals that control the driving of each of the resource factories 230, 250, and 270. At this time, the assembly controller 210 includes control ports 210a, 210b, and 210c that output control information to each of the resource factories 230, 250, and 270 and the control ports 210a, 210b, and 210c are provided to correspond to each of the resource factories 230, 250, and 270.

The assembly controller 210 sets ‘connection 1’ 281 between the output port 230a of the resource A factory 230 and the input port 250a of the resource B factory 250. In addition, the assembly controller 210 sets ‘connection 2’ 283 between the output port 250b of the resource B 250 and the input port 230b of the resource A 230. Therefore, the resource A factory 230 can transmit signals to the resource B factory 250 through ‘the connection 1’ 281 and the resource B factory 250 can transmit signals to the resource A factory 230 through ‘the connection 2’ 283.

In addition, the assembly controller 210 sets ‘connection 3’ 285 between another output port 250c of the resource B factory 250 and the input port 270a of the resource C factory 270. In addition, the assembly controller 210 sets ‘connection 4’ 287 between the output port 270b of the resource C factory 270 and another input port 250d of the resource B factory 250. Therefore, the resource B factory 250 can transmit signals to the resource C factory 270 through ‘the connection 3’ 285 and the resource C factory 270 can transmit signals to the resource B factory 250 through ‘the connection 4’ 287.

Herein, the connections 281, 283, 285, and 287 between each resource factory 230, 250, and 270 are set in one way. The related information is defined and registered in the domain profile 110 in the xml file format.

The assembly controller 210 completes the connection setting between the plurality of resource factories and reports it to the application X factory 100.

In addition, in the SCA structure, the assembly controller 210 in the application X 200 and all the resource factories and the component information in the resource factories are registered in the naming server 120 of the CORBA. Therefore, the resource factory makes an inquiry of information registered in the naming server 120, thereby making it possible to find out the location of the companion component and perform communication based on this.

FIG. 3 shows an internal structure of the resource factory in the application structure of FIG. 2. FIG. 3 describes the resource B factory as one example, but is not limited thereto. As a result, it is natural that it can be applied to the plurality of resource factories.

Referring to FIG. 3, the resource B factory 250 includes a confirmation unit 261 that confirms the workload of at least one of the built-in components 251 and 259, for example, communication signal processing amount and data processing amount and a controller 263 that determines whether the congestion situation occurs according to the confirmed workload and controls the increase and decrease in the components 251 and 259 built in the resource B factory 250 according to the determination result.

The confirmation unit 261 transmits the confirmation result of the workload of the component to the controller 263.

The controller 263 compares the workload of the components 251 and 259 confirmed from the confirmation unit 261 with the registered congestion control threshold to determine whether the congestion situation occurs.

The controller 263 adds or removes the components built in the resource B factory 250 according to whether the congestion situation occurs.

In other words, if the controller 263 senses that the congestion situation occurs, it adds the built-in component to the resource B factory 250. At this time, the controller 263 continuously adds new components until it is determined when the congestion situation is solved due to the setting the workload of the component to the registered congestion control threshold or less.

Of course, the controller 263 can sequentially add new components and simultaneously add a plurality of new components according to the congestion amount of components.

When the components are added by the controller 263 due to the occurrence of the congestion situation, the confirmation unit 261 confirms the workload of the added components.

The controller 263 continuously monitors the workload of the added component from the confirmation unit 261 and if it is determined that the work of the added component ends, removes the added components. At this time, the controller 263 sequentially removes the added components from the recently added components, but is not limited thereto. Of course, when the work of the plurality of components ends, the controller can simultaneously remove the plurality of components.

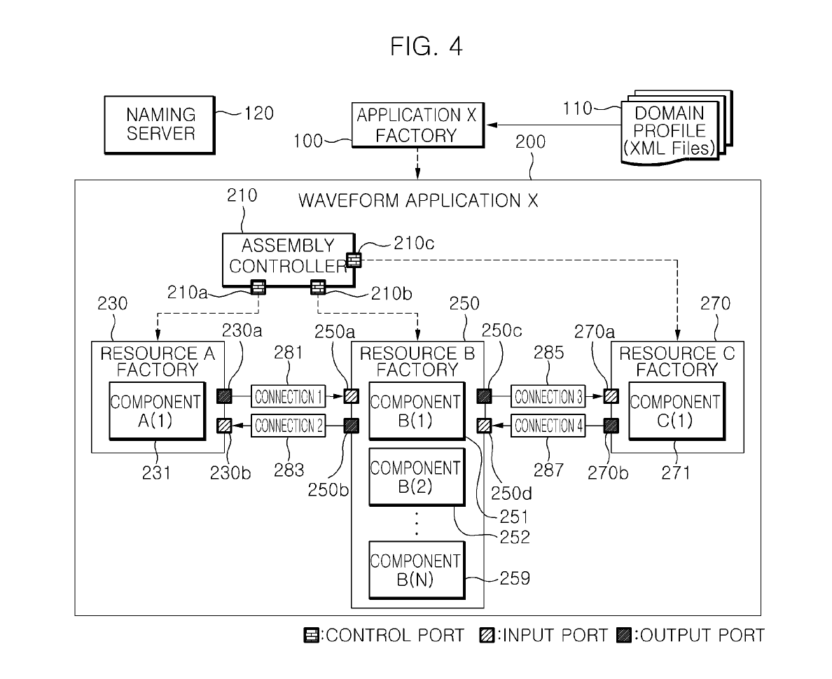

FIG. 4 shows an embodiment in the case where the congestion situation occurs in the component in the application structure of FIG. 2. In particular, FIG. 4 shows a case where the congestion situation occurs in the component of the resource B factory 250.

Referring to FIG. 4, the application X 200 is first driven and the assembly controller 210, the resource A factory 230, the resource B factory 250, and the resource C factory 270 included in the application X 200 are driven. Each of the resource factories 230, 250, and 270 drives one component belonging to their own, that is, the component A(1) 231, the component B(1) 251, and the component C(1), 271. The assembly controller 210 completes the connection setting between each of the resource factories 230, 250, and 270 and outputs the control signals to the corresponding resource factory through each of the control ports 210a, 210b, and 210c. At this time, the resource factory receiving control signals from each of the control port 210a, 210b, and 210c drives the corresponding components according to the control signals input from the assembly controller 210.

Meanwhile, the resource factory has a set congestion control threshold (α). Therefore, each resource factory calculates the workload from the entire communication signal amount and data processing amount of the corresponding resource factory, etc. and compares the calculated workload with the congestion control threshold (α) to determine whether the congestion situation occurs in the component of the corresponding resource factory.

If the workload of the resource B factory 250 exceeds the congestion control threshold during processing of the communication signals and data in the component B(1) 251 of the resource B factory 250, the resource B factory 250 determines that the congestion situation occurs in the component B(1) 251. Therefore, the resource B factory 250 additionally generates the component B(2) 252 and divides the work processed in the component B(1) 251 and assigns it to the component B(2) 252. Therefore, the component B(2) 252 processes the communication signals and data together with the component B(1) 251.

Further, the resource B factory 250 additionally generates the component B(2) 252 and then calculates the workload of the resource B factory 250 again. At this time, the resource B factory 250 confirms whether the calculated workload exceeds the congestion control threshold (α). At this time, when the workload of the resource B factory 250 is the congestion control threshold or less, the resource B factory 250 determines that the congestion situation is solved.

Meanwhile, even though the resource B factory 250 additionally generates the component B(2) 252, when the workload of the resource B factory 250 exceeds the congestion control threshold (α), it determines that the congestion situation of the resource B factory 250 is not solved. As a result, the resource B factory 250 additionally generates new components again, such that the added components process communication signals and data together with the component B(1) 251 and the component B(2) 252. The resource B factory 250 additionally generates a component (N) 259 in the corresponding resource factory until the congestion situation is solved. At this time, the additionally generated multiple components processes the communication signals and data of the resource B factory 250 in parallel, thereby solving the congestion situation in the resource B factory 250.

Thereby, it is advantageous in stably operating the application when the congestion situation occurs while the components in each resource factory are driven in the application X 200.

In addition, when each of the resource factories 230, 250, and 270 add components against the congestion situation, if the congestion situation is solved, the added components should be removed in order to reduce the waste of resources. At this time, the corresponding resource factory sequentially removes the added components from the recently generated component.

In other words, if the resource B factory determines that the congestion situation is solved, the resource B factory 250 confirms the workload of the most recently generated component. When the communication signals and data are continuously applied to the corresponding component, the resource B factory 250 processes the communication signals and data together with other components.

Meanwhile, when the communication signals and data are no longer applied to the corresponding components such that the workload is ‘0’, the resource B factory 250 determines that the work of the corresponding components end, it removes the corresponding components. Thereafter, the resource B factory 250 confirms that the communication signals and data are applied to the most recent components to sequentially remove the components that are no longer needed. For example, when the components added in the resource B factory 250 are component B(2) 252, . . . , component B(N) 259, the resource B factory 250 removes each component added in the corresponding resource B factory 250 in order of component B(N) 259, component B(N−1), . . . , component B(2) 252. At this time, since the resource B factory 250 should basically maintain at least one component, it should not remove but leave component B(1).

Of course, when the congestion situation reoccurs in the corresponding resource factory during the control of the components, the corresponding resource factory adds components again to measure the congestion situation.

The embodiment of FIG. 4 describes, by way of example, the case where the congestion situation occurs in the components in the resource B factory 250, but is not limited thereto. Further, the embodiment can be applied to the case where the congestion situation occurs in the components in the resource A factory 230 or the resource C factory 270.

The operation of the present invention configured as described above will now be described.

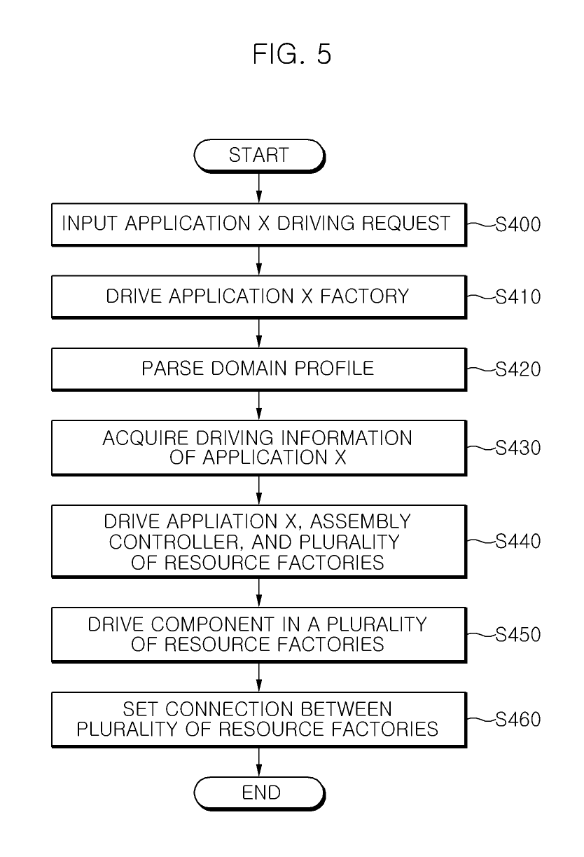

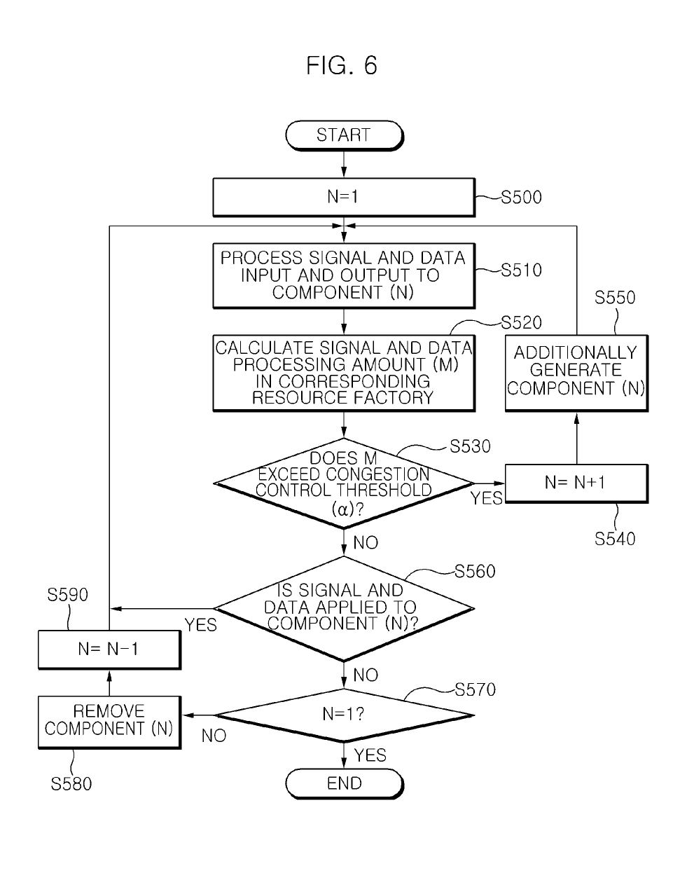

FIG. 5 is a flowchart showing an operational flow of a method for driving the application according to the present invention and FIG. 6 is a flowchart showing an operational flow of a method for controlling congestion of component according to the present invention.

As shown in FIG. 5, the method for driving the application according to the present invention drives the application X factory 100 in the SCA core framework (S410) when the driving request of the application X 200 is input from the outside (S400). At this time, the application X factory 100 extracts and parses the profile information of the application X 200 defined in the domain profile 100 (S420) and acquires the connection information of the application X 200 and the information of the assembly controller 210 from the profile information of the parsed application X 200 (S430).

At this time, the application X factory 100 drives the application X 200, the assembly controller 210, and the plurality of resource factories based on the profile information acquired from the domain profile 110 (S440). Further, the plurality of resource factories drives the components in each resource factory (S450) and the assembly controller 210 sets the connection between the plurality of resource factories according to the connection information of the application X 200 (S460).

Thereafter, the resource factories transmit and receive predetermined data according to the connection set between each resource factory.

Meanwhile, FIG. 6 shows an operational flow of a method for controlling congestion in the application according to the embodiment of the present invention and shows an operation of adding components or removing the added components when the congestion situation occurs (S470).

Referring to FIG. 6, when the resource factory receives control signals through the control port of the assembly controller 210, it drives the components according to the input control signals. At this time, the components in the resource factory processes the control signals input from the assembly controller 210 or processes the communication signals and data input from other resource factories or the communication signals and data output to other resource factories (S510). At this time, the component that processes the communication signals and data input and output to and from the resource factory is assumed to be component N and N is set to 1 at an initial step (S500). In other words, the component 1 processes the communication signals and data that are input from and to the corresponding resource factory at an initial step (S510).

The resource factory calculates the workload M of the communication signals and data that are processed within the corresponding resource factory during the driving of the component 1. At this time, the resource factory compares the workload M calculated at step ‘S520’ with the registered congestion control threshold (α). If the workload M calculated at step ‘S520’ exceeds the registered congestion control threshold (α) (S530), the resource factory determines that the congestion occurs in the component in the corresponding resource factory.

The resource factory shares the communication signals and data processed by the component 1 when the congestion situation occurs and additionally generates new components to be processed. At this time, the resource factory sets N=N+1 (S540) and additionally generates new component N (S550). Herein, since N=2, the resource factory additionally generates the component 2 when the congestion occurs.

Therefore, the component 2 processes the communication signals and data in parallel with the component 1 (S510) to solve the congestion situation of the component 1.

The resource factory calculates the workload M of the communication signals and data processed in the corresponding resource factory (S520) while the component 1 and the additionally generated component 2 processes the communication signals and data of the corresponding resource factory. At this time, if the workload M calculated at step ‘S520’ does not exceed the registered congestion control threshold (α) (S530), the resource factory determines that the congestion situation in the corresponding resource factory is solved.

On the other hand, even though the component 2 is additionally generated, when the workload M of the corresponding resource factory exceeds the registered congestion control threshold (α) (S530), the corresponding resource factory determines that the congestion situation is not solved. At this time, the resource factory performs steps ‘S540’ and ‘S550’, additionally generates new components, and performs steps ‘S510’ to ‘S530’. These steps should be repetitively performed until the workload M of the corresponding resource factory does not exceed the registered congestion control threshold (α).

Meanwhile, if the workload M of the corresponding resource factory does not exceeds the registered congestion control threshold (α) (S530), the resource factory confirms the workload of the most recently generated components. In other words, it confirms whether there are the communication signals and data to be processed in the corresponding component, the corresponding component does not perform any work, etc.

If it is confirmed that the corresponding component continuously processes the communication signals and data, it should repetitively perform steps ‘S510 to S560’ until there are no longer communication signals and data to be processed.

On the other hand, it is confirmed that the corresponding component does not perform any work (S560), the resource factory removes the corresponding component. For example, when the components additionally generated in the corresponding resource factory are component 2, component 3, and component 4, it confirms whether the communication signals and data are applied to the most recently generated component 4. At this time, N is set to 4. If it is confirmed that the component 4 does not perform any work, the resource factory removes the component 4 (S580), N is set to N−1 (S590). Thereafter, the resource factory confirms the workload of the component 3 (S510 and S520).

If it is confirmed that the component 3 does not perform any work (S560), the resource factory removes the component 3 (S580) like the step, N is set to N−1 (S590). Likewise, the resource factory removes all the components down to the component 2 by the above scheme (S580) and then, if there are no communication signals and data applied to the component 1 (S570), ends the driving of the corresponding resource factory.

As described above, the apparatus for controlling components of the application and the method thereof according to the present invention is not limited to the configuration and method of the embodiments described as above, but the embodiments may be configured by selectively combining all the embodiments or some of the embodiments so that various modifications can be made.

What is claimed is:

1. An apparatus for controlling components of an application, the application comprising:
a resource factory that controls driving of a built-in component,
wherein the resource factory includes a confirmation unit that confirms a workload of the built-in component and a controller that determines whether the corresponding component is congested according to the workload confirmed by the confirmation unit and controls the increase and decrease of the component by the determination.

2. The apparatus for controlling components of an application according to claim 1, wherein the controller compares the workload of the confirmed component with a registered congestion control threshold to determine whether the corresponding component is congested.

3. The apparatus for controlling components of an application according to claim 1, wherein it is determined that the congestion situation occurs in the component, the controller adds one or more component.

4. The apparatus for controlling component of application according to claim 3, wherein when the congestion situation occurs in the component, the controller sequentially adds the components.

5. The apparatus for controlling components of an application according to claim 3, wherein when the congestion situation occurs in the component, the controller adds a plurality of components according to the congestion amount occurring in the component.

6. The apparatus for controlling component of application according to claim 3, wherein the controller divides work assigned to the component that is in the congestion situation and assigns the divided work to the added one or more component.

7. The apparatus for controlling components of an application according to claim 3, wherein the controller adds components until the workload of the component that is in the congestion situation is the registered congestion control threshold or less.

8. The apparatus for controlling components of an application according to claim 3, wherein the controller confirms the workload of the added component from the confirmation unit when the congestion situation occurs to remove the worked component among the added components.

9. The apparatus for controlling components of an application according to claim 1, wherein the resource factory is provided in plural.

10. The apparatus for controlling component of application according to claim 9, wherein the plurality of resource factories are set connection between each resource factory.

11. The apparatus for controlling component of application according to claim 9, wherein the resource factory includes an input port receiving signals transmitted from other resource factories and an output port that transmits signals from the corresponding resource factory to other resource factories.

12. A method for controlling components of an application including a resource factory that controls driving of a built-in component, comprising:
confirming workload of the built-in component by the resource factory;
determining whether the corresponding component is congested according to the confirmed workload in the confirmation step; and
controlling the increase and decrease of the component according to the determination result.

13. The method for controlling component of application according to claim 12, wherein the determining includes comparing the workload of the component built in the corresponding resource factory and a registered congestion control threshold.

14. The method for controlling components of an application according to claim 13, wherein when the workload of the component built in the corresponding resource factory exceeds the registered congestion control threshold according to the comparison result of the comparing step, it is determined that the congestion situation occurs.

15. The method for controlling components of an application according to claim 12, wherein if it is determined that the congestion situation occurs in the component, the controlling includes adding one or more component.

16. The method for controlling components of an application according to claim 15, wherein the adding one or more component sequentially adds the component.

17. The method for controlling components of an application according to claim 15, wherein the adding one or more component adds a plurality of components according to the congestion amount occurring in the components.

18. The method for controlling component of application according to claim 15, further comprising dividing work assigned to the components that are in the congestion situation and assigning the divided work to the added components.

19. The method for controlling component of application according to claim 15, wherein the adding is performed until the workload of the components that are in the congestion situation is the registered congestion control threshold or less.

20. The method for controlling components of an application according to claim 15, wherein the controlling further includes confirming the workload of the added components to remove the worked components among the added components.
